(19) United States
(12) Patent Application Publication
(10) Pub. No.: US 2007/0234691 A1
(43) Pub. Date: Oct. 11, 2007

(54) Cyclone and cyclone air purifier and method of air purification thereof

(75) Inventors: Jae Oh Han, Yongin-si (KR); Jai Kwon Lee, Suwon-si (KR); Jin Yong Mo, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/637,143

(22) Filed: Dec. 12, 2006

(30) Foreign Application Priority Data
Apr. 10, 2006 (KR) 2006-32350

(51) Int. Cl. B01D 45/12

(52) U.S. Cl. 55/457

(57) ABSTRACT

A cyclone and a cyclone air purifier include a device with an inlet port structure such that a suction area through which a fluid is suctioned into the cyclone is increased, pressure loss is reduced, and a centrifugal force applied to the fluid is increased, to improve performance of air purification and to reduce noise. The cyclone includes a cylinder into which a fluid is suctioned, a guide extended from the cylinder, an outlet pipe provided in a center of the cylinder to guide a fluid that inversely rises to be discharged, and a vortex induction member provided between the cylinder and the outlet pipe to form vortex channels.

### CROSS-REFERENCE TO RELATED APPLICATIONS

This application claims priority under 35 U.S.C. § 119(a) of Korean Patent Application No. 2006-32350, filed on Apr. 10, 2006, in the Korean Intellectual Property Office, the disclosure of which is incorporated herein in its entirety by reference.

### BACKGROUND OF THE INVENTION

1. Field of the Invention

The present general inventive concept relates to a cyclone to centrifuge a suctioned fluid and a cyclone air purifier having the same, and more particularly, to a cyclone in which a pressure loss of a suctioned fluid is minimized and a centrifugal force of the suctioned fluid is increased, a cyclone air purifier including the cyclone, and a method of air purification associated therewith.

2. Description of the Related Art

In general, a cyclone is a centrifuging apparatus to separate solid particles or droplets that are contained in a fluid by a difference in specific gravity using the centrifugal force generated by a vortex flow of the fluid. A cyclone air purifier is an apparatus in which the cyclone is mounted so that the air that contains foreign substances is centrifuged by the cyclone and air is purified.

A conventional cyclone and a cyclone air purifier are disclosed in Korean Patent Publication No. 10-2005-0110255 and Japanese Patent Publication Nos. 2005-81136 and 2003-1144. FIGS. 1 and 2 illustrate parts similar to those of the cyclone and the cyclone air purifier disclosed in the Patent Publications of the prior art.

FIG. 1 illustrates a conventional cyclone air purifier and FIG. 2 illustrates a conventional cyclone.

As illustrated in FIG. 1, the conventional cyclone air purifier includes an opened-top cylindrical main body 10, a cyclone 20 mounted in the main body 10, a fan 30 installed in the upper side of the cyclone 20 to suction and discharge air, a fan motor 31 to drive the fan 30, and a filter 32 to filter the air discharged from the cyclone 20.

The cyclone 20 will be described in detail with reference to FIG. 2. The cyclone 20 includes a cylinder 21 into which a fluid (e.g., gas or air containing foreign substances and/or particles) is introduced to generate a vortex flow, a cone 23 provided in a lower side of the cylinder 21 such that a diameter is reduced toward a lower part to increase a centrifugal force of a rotating fluid, and an outlet pipe 25 provided in a center of the cylinder 21 to discharge the air that is separated from the rotating fluid to form a rising vortex flow.

An inlet port 22 is formed at a side of the cylinder 21 such that the fluid containing foreign substances is introduced from an outside to the cylinder 21 in a tangential direction. A discharge hole 24 is formed in a lower end of the cone 23 to discharge particles of high specific gravity in the rotating fluid out of the cone 23. An outlet port 26 is formed in an upper end of the outlet pipe 25 to discharge centrifuged and rising air to the outside. The particles that are discharged through the discharge hole 24 are collected in a dust collecting container 12.

Thus, in the conventional cyclone illustrated in FIG. 2, the fluid is introduced through one side of the cylinder 21 to flow to the cone 23 while rotating in a tangential direction of an inner surface of the cylinder 21 and to rotate by a larger centrifugal force so that large particles are discharged and the air generates a rising vortex flow in the center of the cone 23, to be introduced into the outlet pipe 25, and to be discharged through the outlet port 26. As a result, the foreign substances are separated from the air.

In the cyclone air purifier illustrated in FIG. 1 in which the above-described cyclone is provided, the fan 30 rotates to generate low pressure around the inlet port 22 so that the air containing the foreign substances is suctioned from surrounding air into the inlet port 22 and that the air that is centrifuged in the cyclone 20 and is discharged from the cyclone 20 is discharged to a discharge guide cylinder 11 and is filtered by the filter 32 to be finally discharged to the outside. As a result, the air is purified.

However, in the above-described conventional cyclone air purifier or cyclone, the inlet port for suctioning the fluid is formed on the side of the cylinder in a form of a duct so that a pressure loss is generated by frictional resistance while the fluid is suctioned. Also, in view of a structure of the conventional cyclone air purifier, since the fluid is suctioned only through one side of the cyclone, when the fluid is suctioned in several directions, the centrifugal force that is applied to the fluid is much smaller than the centrifugal force that the cyclone can actually apply to the fluid.

Also, after the fluid is suctioned into the cyclone, since a flow direction of the fluid is not uniform, the centrifugal force may not be properly applied to the fluid so that there is an increase in pressure loss and centrifugation is not sufficiently performed.

Also, in the above-described conventional cyclone air purifier, since a tangential velocity at which the fluid enters the cyclone is reduced due to the pressure loss of the suctioned fluid that is generated in the cyclone, it is not possible to obtain a sufficient flow rate. When the capacity of the fan is increased or the fan is driven faster in order to obtain sufficient flow rate, costs and noise increase.

### SUMMARY OF THE INVENTION

The present general inventive concept provides a cyclone including a device to solve a structural limitation of an inlet port so that a suction area through which a fluid is suctioned into the cyclone is increased, a pressure loss is reduced, and a centrifugal force applied to the fluid is increased, and a cyclone air purifier including the cyclone to improve air purification performance and noise reduction.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a cyclone including a cylinder into which a fluid is suctioned, a guide extended from the cylinder, an outlet pipe provided in a center of the cylinder to guide a fluid that inversely rises to be discharged, and a vortex induction member provided between the cylinder and the outlet pipe to form vortex channels.

An opening through which a fluid is introduced from an outside may be formed in an upper end of the cylinder.

The vortex induction member may include at least one spiral guide blade.

At least one inlet port of a fluid that is partitioned off by a guide blade and the outlet pipe may be formed in the opening.

A number of guide blades may be two, three, or four.

Starting points of the guide blades may be a same height as ending points of the guide blades.

The plurality of guide blades may be formed to rotate in a same direction in a position where the opening is divided into two, three, or four.

A rotation angle of the guide blades is equal to or greater than 90 degrees.

The vortex induction member is formed in an outer circumference of the outlet pipe to be attached to and detached from an inside of the cylinder.

The vortex induction member is formed in an inner surface of the cylinder and a coupling groove corresponding to the vortex induction member is formed in an outer circumference of the outlet pipe so that the outlet pipe is attached to and detached from a center of the cylinder.

The foregoing and/or other aspects of the present general inventive concept may also be achieved by providing a cyclone air purifier including a main body, a fan installed in an upper side of the main body, and a cyclone installed in the main body. The cyclone may include a cylinder having an opening formed in an upper end thereof, a guide extended from the cylinder, an outlet pipe provided in a center of the cylinder to guide a fluid that inversely rises to be discharged, and a vortex induction member provided between the cylinder and the outlet pipe to form vortex channels. The fluid may be sucked in from an outside in to the opening by the fan so that foreign substances in the suctioned fluid are centrifuged.

The vortex induction member may include at least one spiral guide blade.

At least one inlet port of a fluid that is partitioned off by the guide blade and the outlet pipe may be formed in the opening.

A number of guide blades may be two, three, or four.

Starting points of the guide blades may be a same height as ending points of the guide blades.

The guide blades may be formed to rotate in a same direction in a position where the opening is divided into two, three, or four.

A rotation angle of the guide blades may be equal to or greater than 90 degrees.

An outlet port from which air is discharged from the outlet pipe is positioned above the opening.

The cyclone air purifier may further include a first partition installed in the upper end of the cylinder and having a communication hole to communicate with the opening, a second partition installed in an upper end of the outlet pipe and having a closely-contacting hole to be closely contacted with the outlet pipe, a suction grill installed between the first partition and the second partition, and a suction space defined by the first partition, the second partition, and the suction grill.

The foregoing and/or other aspects of the present general inventive concept may also be achieved by providing a cyclone including a cylinder having a cylindrical body and an opening formed in an end thereof to receive a fluid in a first direction, an outlet pipe disposed in the cylindrical body to discharge the fluid in a second direction opposite to the first direction, and an induction member disposed between the cylindrical body and the outlet pipe to guide the received fluid in a third direction having an angle with the first and second directions.

The foregoing and/or other aspects of the present general inventive concept may also be achieved by providing a method of operating a cyclone, the method including receiving a fluid through an opening formed in an end of a cylindrical body of a hollow cylinder in a first direction, guiding the fluid in a second direction opposite to the first direction through an outlet pipe disposed in the cylindrical body of the cylinder, and guiding the fluid from the opening in a third direction having an angle with the first and second direction using an induction member disposed between the cylindrical body and the outlet pipe.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a conventional cyclone air purifier;

FIG. 2 illustrates a conventional cyclone;

FIG. 3 is an exploded perspective view illustrating a cyclone air purifier according to an embodiment of the present general inventive concept;

FIG. 4 is an exploded perspective view illustrating a main part of the cyclone air purifier of FIG. 3;

FIG. 5 illustrates an internal structure of a cyclone according to an embodiment of the present general inventive concept;

FIGS. 6 and 7 are views illustrating a process of assembling a cyclone according to an embodiment of the present general inventive concept;

FIGS. 8, 9, 10, and 11 are views illustrating experimental examples of a cyclone according to embodiments of the present general inventive concept; and

FIG. 12 is a graph illustrating experimental results of the experimental examples of the cyclone of FIGS. 8, 9, 10, and 11.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

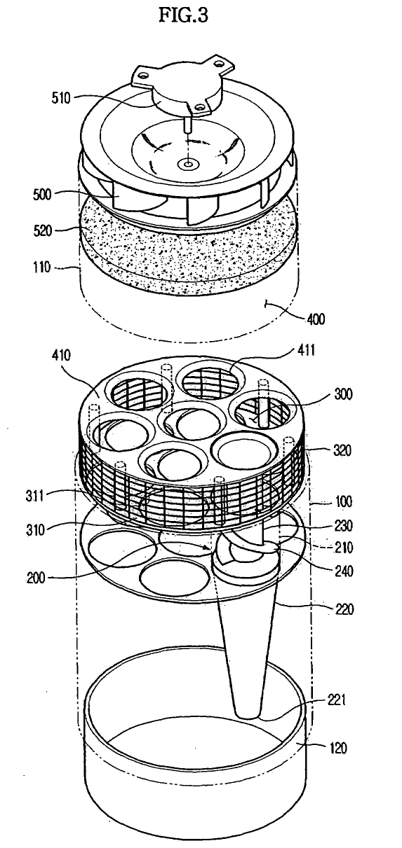

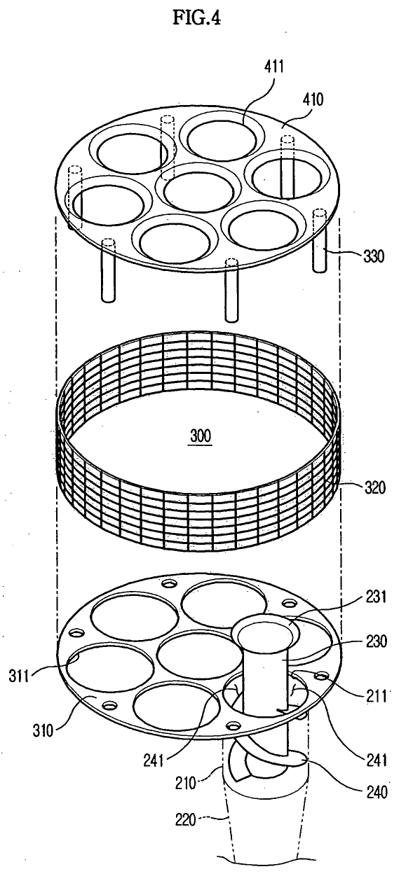

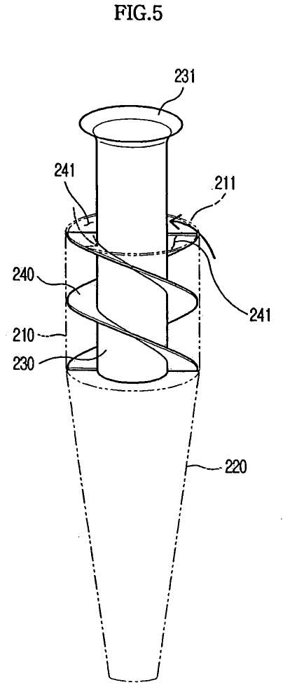

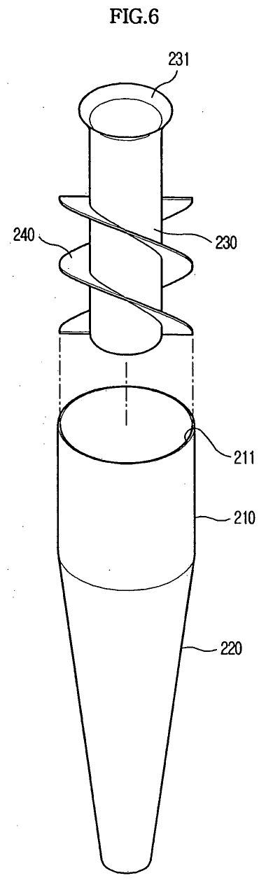

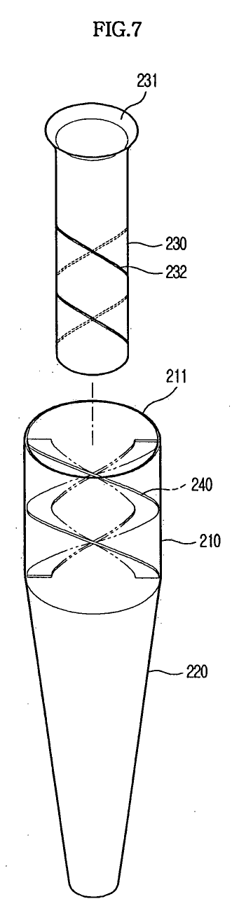

FIG. 3 is an exploded perspective view illustrating a cyclone air purifier according to an embodiment of the present general inventive concept, FIG. 4 is an exploded perspective view illustrating a main part of the cyclone air purifier of FIG. 4, FIG. 5 illustrates a cyclone according to embodiments of the present general inventive concept, and FIGS. 6 and 7 are views illustrating a process of assembling a cyclone according to an embodiment of the present general inventive concept.

Referring to FIG. 5, the cyclone includes a cylinder 210 into which a fluid is suctioned from outside to generate a vortex flow, a guide 220 provided in a lower side of the cylinder 210 to increase a centrifugal force applied to a rotating fluid, and an outlet pipe 230 to guide air rising and rotating in a center of the cyclone to be discharged. The cyclone further includes one or more guide blades 240 as one or more vortex induction members that are provided between an inner surface of the cylinder 210 and an outer circumference of the outlet pipe 230 to guide the fluid suctioned into the cylinder 210 to be rotated at a predetermined angle in a tangential direction to the inner surface of the cylinder 210 and to thus increase the centrifugal force applied to the fluid. The fluid may be air containing particles.

Guide pipes or guide ribs other than the guide blades 240 may be used as the vortex induction members. However, in the present embodiment, the guide blades are used as the vortex induction members in view of a pressure loss of the fluid.

The upper end of the cylinder 210 is opened to form an opening 211 through which the fluid is suctioned from the outside. The guide blades 240 are spirally formed at a predetermined angle to form inlet ports 241 in the opening 211. A number of the inlet ports 241 is the same as the guide blades 240. In the cyclone illustrated in FIG. 5, the number of guide blades 240 is two. However, the number may be changed. A solid line arrow and a dotted line arrow illustrated in FIG. 5 represent that the fluid enters the respective inlet ports 241 formed in the opening 211 by the corresponding guide blades 240.

The outlet pipe 230 is extended such that an outlet port 231, through which the air that is centrifuged in the cyclone to rise is discharged, is positioned at a position higher than the opening 211 of the cylinder. By doing so, the fluid containing foreign substances is prevented from being mixed with the air from which the foreign substances are separated. A discharge hole 221 is formed in a lower end of the guide 220 so that particles of relatively high specific gravity, separated from the rotating fluid, are discharged through the discharge hole 221.

Referring to FIGS. 5 and 6, the guide blades 240 are formed on the outer circumference of the outlet pipe 230 as a single unit to be attached to and detached from the cylinder 210 through the opening 211. Due to this structure, since a number of guide blades 240 and a rotation angle with respect to a length in which the guide blades 240 travel may vary, it is possible to freely control an angle at which fluid is suctioned and an angle at which the fluid rotates. Also, attachment of the guide blades 240 may be carried out by various methods. For example, the guide blades 240 may be tightly fitted into the cylinder 210 using friction between ends of the guide blades 240 and an inner surface of the cylinder 210, or the guide blades 240 may be coupled with the cylinder 210 such that lower ends of the guide blades 240 are locked to an upper end of the guide 220. Otherwise, grooves (not shown) corresponding to the ends of the guide blades 240 are formed on the inner surface of the cylinder 210 such that the guide blades 240 are rotated and fastened with the grooves and as a result the guide blades 240 are coupled with the cylinder 210.

Referring to FIGS. 3 and 7, the guide blades 240 are coupled with the cylinder 210 such that the guide blades 240 are formed on the inner surface of the cylinder 210 and the outlet pipe 230 is inserted into a center. At this case, the outlet pipe 230 may be inserted into inner ends of the guide blades 240 using a frictional force and, as illustrated in FIG. 7, coupling grooves 232 corresponding to the inner ends of the guide blades 240 may be formed on an outer circumference of the outlet pipe 230 so that the coupling grooves 232 are rotated and fastened to the inner ends of the guide blades 240.

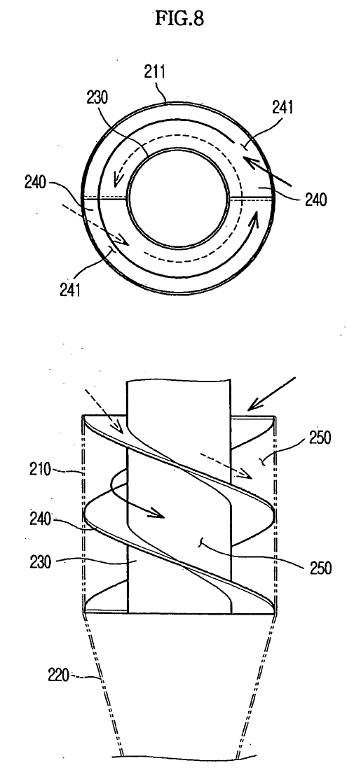

Operation of a cyclone will be described in detail with reference to FIGS. 8 to 11. A fluid is introduced into inlet ports 241 that are formed in opening 211 in an upper end of a cylinder 210 by an outlet pipe 230 and guide blades 240 in directions indicated by solid line arrows and dotted line arrows, and flows along vortex channels 250 formed in the cylinder 210 by the guide blades 240 so that the fluid naturally has a centrifugal force. The fluid that flows along the vortex channels 250 generates a vortex flow at high speed in a guide 220.

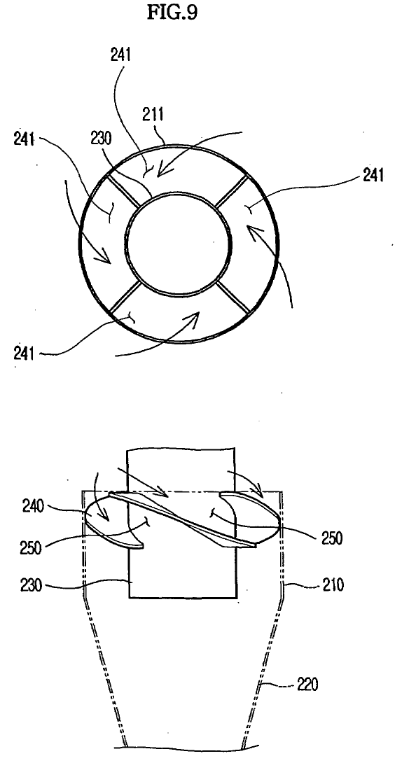

A number of guide blades 240 may be two or four as illustrated in FIGS. 8 to 11. FIGS. 8, 10, and 11 illustrate examples of cyclones having two guide blades and inlet parts. FIG. 9 illustrates an example of the cyclone having four guide blades and four inlet ports. A plurality of guide blades 240 may be formed such that starting points of the guide blades 240 are positioned at a same height as ending points of the guide blades 240. When the number of guide blades 240 is two, the guide blades 240 may be formed to rotate in a same direction in a position where the opening 211 is divided into two. When the number of guide blades 240 is three or four, the guide blades 240 may be formed to rotate in the same direction in the position where the opening 211 is divided into three or four.

In the cyclone according to the embodiment of the present general inventive concept, unlike in the conventional cyclone, since the fluid is not introduced into a side but is directly introduced into an opening formed in an upper end of a cylinder without pressure loss and, as illustrated in FIGS. 8 to 11, the two or four guide blades 240 are formed so that the two or four inlet ports 241 are formed, and suction area is increased. Also, the three guide blades 240 may be formed so that three inlet ports are formed (not shown).

A cyclone air purifier that adopts the above-described cyclone will be described with reference to FIGS. 3 and 4.

As illustrated in FIG. 3, the cyclone air purifier according to the present general inventive concept includes at least one cyclone 200 provided in a main body 100 to form an external appearance and a suction space 300 formed in an upper end of the main body 100, that is, in an upper end of a cylinder 210 of the cyclone 200 and which is in communication with the cylinder 210.

As illustrated in FIG. 4, the suction space 300 is defined by a lower first partition 310, an upper second partition 410, and a suction grill 320 installed between the first and second partitions 310 and 410.

Communication holes 311 that have substantially a same diameter as a diameter of an opening 211 formed in the upper end of the cylinder 210 of the cyclone 200 are formed in the first partition 310 so that fluid in the suction space 300 is introduced into inlet ports 241 of opening 211 through the communication holes 311.

The second partition 410 is supported by supporting members 330 on the first partition 310, and the second partition 410 is maintained at a predetermined distance above the first partition 310. As illustrated in FIG. 3, the suction space 300 is formed under the second partition 410 and a discharge space 400 is formed above the second partition 410. That is, an upper space of the second partition 410 is covered with a discharge guide cylinder 110 to form the discharge space 400 in which air discharged from the cyclone 200 is collected.

The second partition 410 is formed with closely-contacting holes 411 to closely contact an upper end of an outlet pipe 230 so that the discharge space 400 is in communication with the suction space 300. This prevents fluid in the suction space 300 from being mixed with the air in the discharge space 400.

As illustrated in FIG. 3, a dust collecting container 120 is provided in a lower side of the main body 100 so that foreign substances separated and discharged from the cyclone 200 are collected, and a filter 520 for further filtering the discharged air, a fan 500, and a fan motor 510 are provided in an upper side of the discharge space 400. A cyclone 200 may be similar to the cyclone illustrated with reference to FIGS. 5 to 7.

Hereinafter, operation of the cyclone air purifier according to the present general inventive concept illustrated in FIGS. 3 and 4 will be described.

Since the fan 500 is rotated by the fan motor 510 to suction the air in from a lower side thereof and to discharge the air in a radial direction, low pressure is formed in the suction space 300 communicated with ambient air so that the fluid is sucked in from outside through the suction grill 320.

The fluid sucked into the suction space 300 is introduced into the inlet ports 241 formed in the opening 211 of the cyclone 200 through the communication holes 311 formed in the first partition 310, and the suctioned fluid flows along guide blades 240 and is applied by centrifugal force to thus generate a falling vortex flow. At this time, rotation velocity of the falling vortex flow increases in guide 220 so that the centrifugal force is increased and the foreign substances are collected into the dust collecting container 120 through the discharge hole 221 in a lower end of the guide 220. The air from which the foreign substances are separated rises while generating a rising vortex flow in a center of the cyclone 200, is discharged through an outlet port 231 along an outlet pipe 230, is collected in the discharge space 400, is filtered again by the filter 520 along the discharge guide cylinder 110, and is finally discharged to the outside through the fan 500.

The operation and effect of the cyclone and/or the cyclone air purifier according to the present general inventive concept will be described.

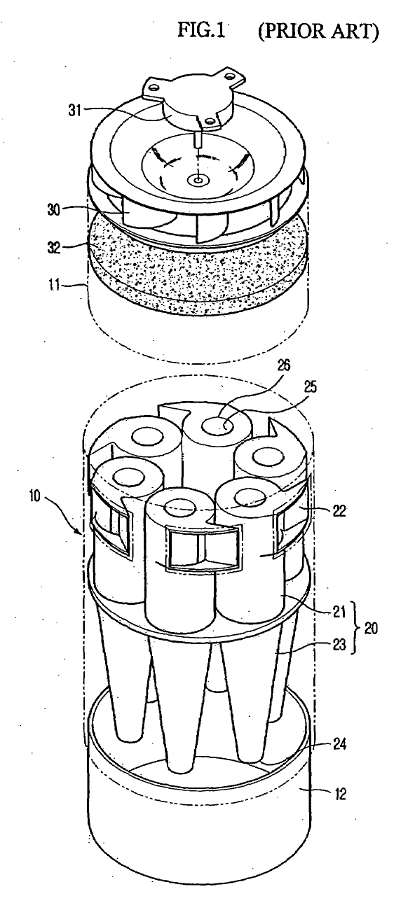

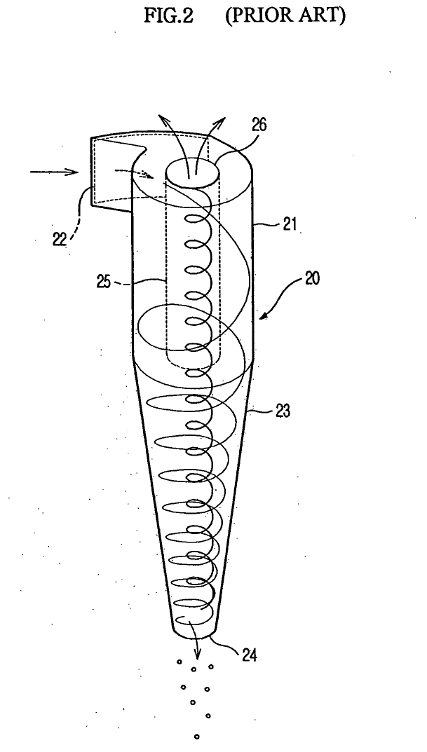

In the conventional cyclone air purifier illustrated in FIG. 1, since the inlet port of the fluid is formed only in a part of the upper side of the main body and is narrow, a great deal of frictional resistance is generated while suctioning the fluid and the fluid cannot flow at sufficient velocity due to the pressure loss. This constitutes a structural loss which is ineffective in suctioning the fluid. However, in the cyclone air purifier according to the general inventive concept, since the space formed in the upper side of the main body and in the upper side of the cylinder can be used as the suction space and the plurality of inlet ports are formed in the openings in the upper ends of the cylinders of the cyclone to solve the structural loss of the conventional cyclone air purifier which has the fluid introduced into only one direction, the fluid is suctioned more effectively and the suction area is increased. Also, since the fluid is directly suctioned from the suction space into the cylinder through the upper end of the cyclone, the pressure loss is remarkably reduced.

Moreover, since the guide blades form the vortex channel such that the fluid flow uniformly and the vortex flow is naturally generated by the centrifugal force, a higher flow rate can be achieved even if fan driving conditions are the same.

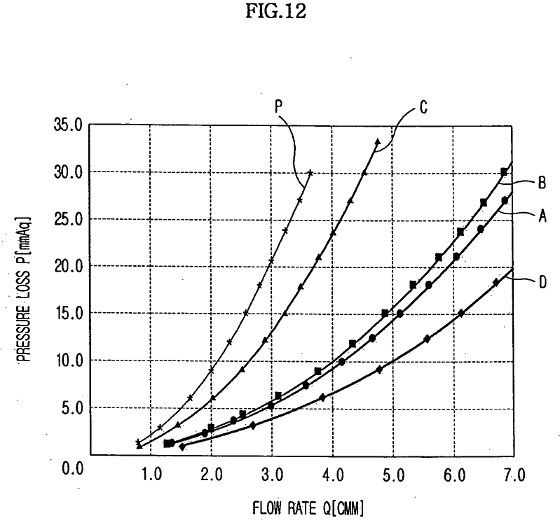

The effect of the present general inventive concept will be described in detail with reference to experimental examples illustrated in FIGS. 8 to 11 and a graph of experimental results illustrated in FIG. 12.

FIGS. 8 to 11 illustrate cyclones in which various guide blades 240 are formed and which are seen from above and front. The solid line arrows and the dotted line arrows illustrated in FIGS. 8 to 11 represent that the fluid is introduced through the inlet ports 241 and flows along the vortex channels 250 formed in the guide blades 240.

The graph of FIG. 12 illustrates a relationship between the pressure loss and flow rate of fluids in the conventional cyclone air purifier and the cyclone air purifier according to the preferred embodiment of the present general inventive concept illustrated in FIGS. 8 to 11 under the same conditions. In other words, a vertical axis represents the pressure loss in units of mmAq (1 atmosphere pressure (atm)*10332 mmAq) and a horizontal axis represents the flow rate of the cyclone air purifier in units of CMM (m3/min or cubic meters per minute).

In the graph illustrated in FIG. 12, P represents an experimental result of the conventional cyclone air purifier and A, B, C, and D represent experimental results of cyclone air purifiers in which the cyclones illustrated in FIGS. 8, 9, 10, and 11 are employed respectively.

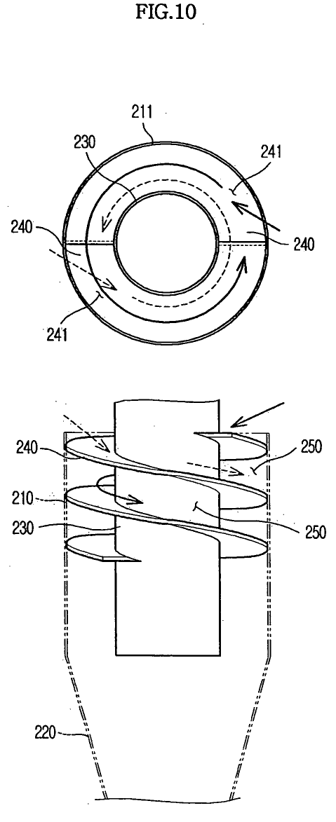

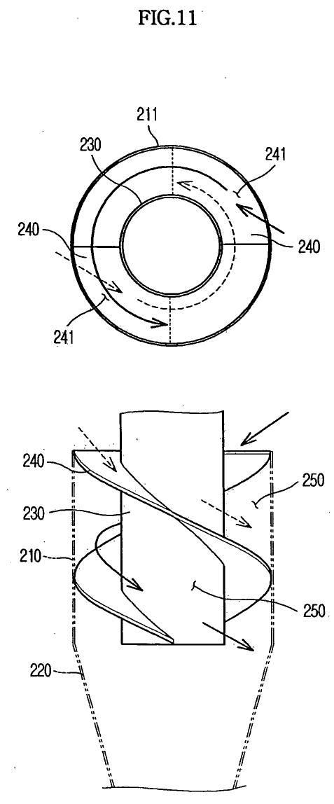

FIG. 8 illustrates the cyclone (that is employed in the cyclone air purifier whose experimental result is represented by A of FIG. 12) in which two guide blades 240 are rotated by 360 degrees in a length of 100 mm in a vertical direction. FIG. 9 illustrates the cyclone (that is employed in the cyclone air purifier whose experimental result is represented by B of FIG. 12) in which four guide blades 240 are rotated by 90 degrees in a length of 25 mm in the vertical direction. FIG. 10 illustrates the cyclone (that is employed in the cyclone air purifier whose experimental result is represented by C of FIG. 12) in which the two guide blades 240 are rotated by 360 degrees in a length of 50 mm in the vertical direction. FIG. 11 illustrates the cyclone (that is employed in the cyclone air purifier whose experimental result is represented by D of FIG. 12) in which the two guide blades 240 are rotated by 270 degrees in a length of 100 mm in the vertical direction.

As illustrated in the graph of FIG. 12, curves that illustrate a relationship between the pressure loss and the flow rate of the cyclone air purifiers whose experimental results are represented by A to D, are inclined to the right side, and have gentle slopes compared with a curve that illustrates a relationship between the pressure loss and the flow rate of the cyclone air purifier whose experimental result is represented by P, which shows that performance of the cyclone air purifier according to the embodiment of the present general inventive concept is higher than performance of the conventional cyclone air purifier.

Among the cyclone air purifiers whose experimental results are represented by A to D, the cyclone air purifier whose experimental result is represented by D has the highest performance and the cyclone air purifier whose experimental result is represented by C has the lowest performance.

Performance of a cyclone air purifier varies with a number of guide blades, a length in which the guide blades are formed, and a rotation angle of the guide blades. The number of guide blades is preferably two to four. This is because performance of vortex channels of fluid flow deteriorates when only one guide blade is formed and pressure loss increases when more than four guide blades are formed.

As it can be understood from the graph of the experimental results illustrated in FIG. 12, the rotation angle of the guide blades of the cyclone according to the embodiment of the present general inventive concept is equal to or greater than 90 degrees so that the cyclone air purifier according to the present general inventive concept has higher performance than the cyclone air purifier in which the conventional cyclone is mounted.

The rotation angle of the guide blades may be about 180 degrees to 360 degrees. This is because the pressure loss increases when the rotation angle of the guide blades is larger than 360 degrees and the performance of the vortex channels of the fluid flow deteriorates when the rotation angle of the guide blades is less than 180 degrees. The performance of the vortex channels of the fluid flow may be shown to some extent when four guide blades are formed to rotate at 90 degrees as illustrated in B of the graph. However, when two guide blades are formed to rotate at 90 degrees, the performance deteriorates to some extent. Therefore, when the two to four guide blades are formed, the guide blades may be formed to rotate at about 180 degrees to 360 degrees to provide more pressure loss and effect better air purification.

In the cyclone and the cyclone air purifier according to the present general inventive concept having the above-described aspects, the pressure loss is reduced when the fluid is sucked in and the suction area of the fluid is increased. The fluid is guided to flow in a uniform direction in the cyclone so that the centrifugal force is increased. Therefore, the performances of the cyclone and the cyclone air purifier are improved and fan noise is reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A cyclone comprising:
a cylinder into which a fluid is suctioned;
a guide extended from the cylinder;
an outlet pipe provided in a center of the cylinder to guide a fluid that inversely rises to be discharged; and
a vortex induction member provided between the cylinder and the outlet pipe to form one or more vortex channels.

2. The cyclone according to claim 1, wherein the cyclone comprises an opening through which the fluid is introduced from an outside and which is formed in an upper end thereof.

3. The cyclone according to claim 1, wherein the vortex induction member comprises at least one spiral guide blade.

4. The cyclone according to claim 3, wherein the cylinder comprises at least one inlet port to partition off the fluid by the at least one guide blade, and the outlet pipe is formed in the opening.

5. The cyclone according to claim 3, wherein the at least one guide blade comprises two or more guide blades.

6. The cyclone according to claim 5, wherein starting points of the guide blades are a same height as ending points of the guide blades.

7. The cyclone according to claim 5, wherein the cylinder comprises an opening to receive the suctioned fluid, and the guide blades are formed to rotate in a same direction in a position where the opening is divided into two or more.

8. The cyclone according to claim 3, wherein a rotation angle of the at least one guide blade is equal to or greater than 90 degrees.

9. The cyclone according to claim 1, wherein the vortex induction member is formed in an outer circumference of the outlet pipe to be attached to and detached from an inside of the cylinder.

10. The cyclone according to claim 1, wherein the vortex induction member is formed in an inner surface of the cylinder, and the outlet pipe comprises a coupling groove corresponding to the vortex induction member and is formed in an outer circumference thereof so that the outlet pipe is attached to and detached from a center of the cylinder using the coupling groove.

11. A cyclone air purifier comprising:
a main body;
a fan installed in an upper side of the main body; and
a cyclone installed in the main body, comprising:
a cylinder having an opening formed in an upper end thereof,
a guide extended from the cylinder,
an outlet pipe provided in a center of the cylinder to guide a fluid that inversely rises to be discharged, and
a vortex induction member provided between the cylinder and the outlet pipe to form vortex channels,
wherein the fluid is sucked in from an outside to the opening by the fan so that foreign substances in the suctioned fluid are centrifuged.

12. The cyclone air purifier according to claim 11, wherein the vortex induction member comprises at least one spiral guide blade.

13. The cyclone air purifier according to claim 12, wherein the cylinder comprises at least one inlet port formed at the opening to partition off the fluid by the guide blade and the outlet pipe.

14. The cyclone air purifier according to claim 12, wherein the at least one spiral guide blades comprises to or more guide blades.

15. The cyclone air purifier according to claim 14, wherein starting points of the guide blades are a same height as ending points of the guide blades.

16. The cyclone air purifier according to claim 14, wherein the guide blades are formed to rotate in a same direction in a position where the opening is divided into two or more.

17. The cyclone air purifier according to claim 12, wherein a rotation angle of the guide blades is equal to or greater than 90 degrees.

18. The cyclone air purifier according to claim 11, wherein the cylinder comprises an outlet port positioned above the opening to discharge the air from the outlet pipe.

19. The cyclone air purifier according to claim 18, further comprising:
a first partition installed in the upper end of the cylinder and having a communication hole in communication with the opening;
a second partition installed in an upper end of the outlet pipe and having a closely-contacting hole to closely contact the outlet pipe;
a suction grill installed between the first partition and the second partition; and
a suction space defined by the first partition, the second partition, and the suction grill.
